(19) United States
(12) Patent Application Publication
(10) Pub. No.: US 2007/0226034 A1
(43) Pub. Date: Sep. 27, 2007

(54) Wireless communication device meeting scheduler

(75) Inventor: Sameer Khan, Margao (IN)

Correspondence Address: KYOCERA WIRELESS CORP., P.O. BOX 928289, SAN DIEGO, CA, 92192-8289, US

(73) Assignee: KYOCERA WIRELESS CORP.

(21) Appl. No.: 11/389,647

(22) Filed: Mar. 23, 2006

(51) Int. Cl. G06F 15/02

(52) U.S. Cl. 705/9

(57) ABSTRACT

Systems and methods for scheduling meetings between users of wireless communication devices allow the wireless communication device of a meeting organizer to schedule a meeting with one or more attendees. At the appointed time of the scheduled meeting, the wireless communication device of the meeting organizer (or an appointed deputy device) may conduct an electronic roll call through a local wireless means or a network wireless means. Confirmed attendees that are not present may then be located using location utilities such as GPS, triangulation, or network based location tracking.

### FIELD OF INVENTION

The present invention generally relates to wired and wireless communication devices and more particularly relates to scheduling meetings between users of wireless communication devices.

### BACKGROUND

Today's wireless communication devices are typically equipped with a schedule or calendar application that allows a user of the device to keep track of events, meeting, appointments, etc. However, these applications are not efficient for and most often are not capable of arranging events or scheduling meetings with others.

Recently some attention has been focused on these limitations in the conventional systems, including the solutions proposed in U.S. patent application publication number 2005-0038690 (“Hayes-Roth”). Hayes-Roth teaches a hook-up assistant that is capable of consulting the various calendars, schedules, preferences, etc. for each potential attendee and then tentatively scheduling a meeting between the various parties. The hook-up assistant then proceeds to confirm the tentative meeting behind the scenes in an attempt to eliminate phone tag between the principles.

According to Hayes-Roth, once a scheduled meeting is confirmed between hook-up assistant modules, no further action is taken. This proposed solution therefore merely is a calendaring utility capable of identifying an available time period amongst a group of potential attendees and then reserving that time period and then confirming a meeting during that time period.

Relatedly, U.S. Pat. No. 6,757,530 (“Rouse”) proposed a system for providing a wireless device with access to a network based scheduling application. Rouse teaches that a wireless device can access a scheduling server so that a single source may track the schedules for many different parties in order to facilitate the scheduling of meetings between the various parties and other events, etc.

The teachings in Rouse and Hayes-Roth and conventional scheduling solutions fail to address the complete needs of meeting organizers and attendees. Accordingly, what is needed is a system and method that overcomes these significant problems found in the conventional systems as described above.

### SUMMARY

Accordingly, described herein are systems and methods for scheduling meetings between users of wireless communication devices and initializing such meetings so that the organizer may confirm the presence of all confirmed attendees. The wireless communication device of the organizer facilitates the scheduling of the meeting and at the appointed time conducts an electronic roll call of the confirmed attendees to verify that each confirmed attendee is present at the meeting location. Alternatively, an appointed deputy device or a combination of devices may conduct the roll call. Confirmed attendees that are not present may then be located using location utilities such as GPS, triangulation, or network based location tracking.

To schedule a meeting, the meeting organizer enters the meeting parameters including a list of potential attendees. The meeting is tentatively scheduled on the wireless communication device of the organizer and attendees are looked up in the contacts list on the wireless communication device of the organizer and sent an invitation. On the wireless communication device of an attendee, the invitation is received and a response is returned to the meeting organizer. The meeting organizer, upon receipt of a response from the first confirmed attendee, updates the tentatively scheduled meeting to make it a scheduled meeting and adds the attendees name and contact information to a list of attendees for the meeting.

When the start time of the scheduled meeting arrives, the wireless communication device of the organizer obtains the list of confirmed attendees and conducts a wireless roll call of the confirmed attendees. The organizer can then be notified via the user interface of those in attendance and absentees can be located via wireless means.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 is a high level network diagram illustrating an example system for scheduling meetings according to an embodiment of the present invention;

FIG. 2 is a block diagram illustrating an example handset that is part of a system for scheduling meetings according to an embodiment of the present invention;

FIG. 3 is a flow diagram illustrating an example process for scheduling a meeting by an organizer according to an embodiment of the present invention;

FIG. 4 is a flow diagram illustrating an example process for scheduling a meeting by an invitee according to an embodiment of the present invention;

FIG. 5 is a flow diagram illustrating an example process for initiating a scheduled meeting according to an embodiment of the present invention;

FIG. 6 is a block diagram illustrating an example process for taking roll call at a scheduled meeting according to an embodiment of the present invention;

FIG. 7 is a block diagram illustrating an exemplary wireless communication device that may be used in connection with the various embodiments described herein; and

FIG. 8 is a block diagram illustrating an exemplary computer system that may be used in connection with the various embodiments described herein.

### DETAILED DESCRIPTION

Certain embodiments as disclosed herein provide for systems and methods for locating a user of a target wireless communication device and allowing the target wireless communication device to deny the location request or respond to the location request with its current location or a default location. For example, one method as disclosed herein allows for a request for the location of a target wireless communication device to be responded to by the network or by the target device. Advantageously, the target device may respond on a granular, per request basis so that the user of the target device can selectively deny or respond to location requests in an appropriate fashion.

After reading this description it will become apparent to one skilled in the art how to implement the invention in various alternative embodiments and alternative applications. However, although various embodiments of the present invention will be described herein, it is understood that these embodiments are presented by way of example only, and not limitation. As such, this detailed description of various alternative embodiments should not be construed to limit the scope or breadth of the present invention as set forth in the appended claims.

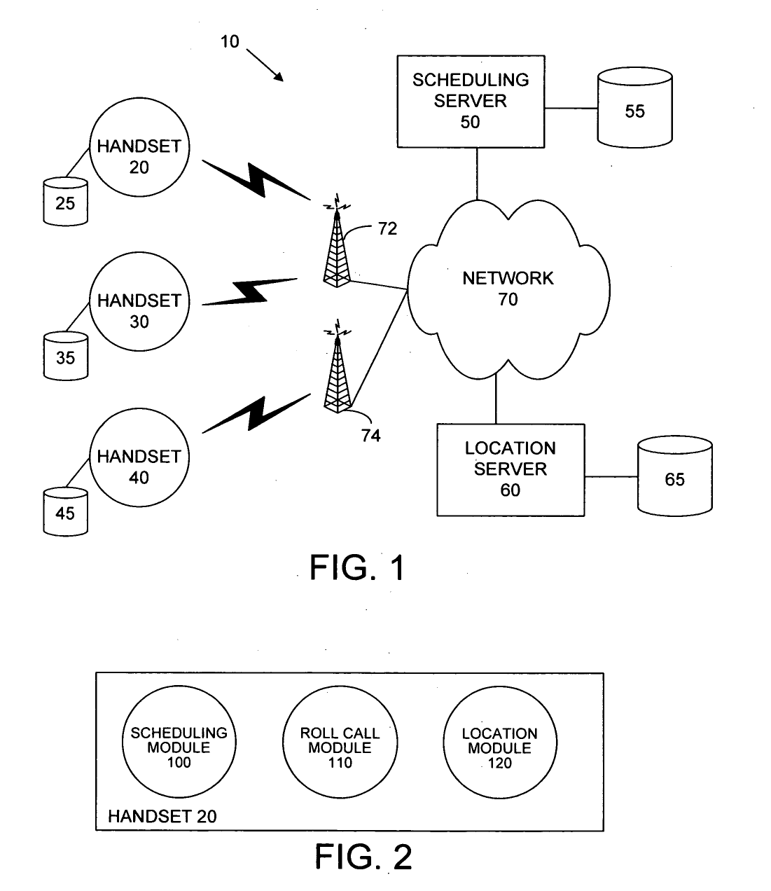

FIG. 1 is a high level network diagram illustrating an example system for scheduling meetings according to an embodiment of the present invention. In the illustrated embodiment, the system 10 comprises a plurality of wireless communication devices (also referred to herein as handsets or mobile phones) such as handsets 20, 30, and 40. Each handset is configured with an internal or external (or both) data storage area such as areas 25, 35, and 45, respectively. The handsets 20, 30 and 40 are communicatively coupled with one or more networks such as network 70 via one or more base stations such as base stations 72 and 74. The system 10 also comprises a scheduling server 50 that is configured with a data storage area 55 and is communicatively coupled with the handsets via the network 70. The system 10 additionally comprises a location server 60 that is configured with a data storage area 65 and is communicatively coupled with the handsets via the network 70.

The handsets 20, 30 and 40 can be any of a variety of wireless communication devices. For example, handset 20 can be a cell phone, laptop computer, personal digital assistant, tablet computer, palmtop computer, or any other such device with the ability to communicate with the network 70 via a wireless connection. The handsets 20, 30 and 40 are configured with data storage areas 25, 35 and 45 respectively. The data storage areas may be internal or external storage devices and may also be removable storage devices.

The handsets 20, 30 and 40 are also configured with certain modules such as a scheduling module (not shown) and a location module (not shown). These modules may be implemented in hardware or software or some combination of the two. For example, a module may be a resident software application that is integrated with the controlling software (e.g., operating system) on a handset. Alternatively, a module may be an integrated circuit that is incorporated into the electronics of the handset. Additionally, a module may be an application specific integrated circuit that includes both hardware and software components.

The scheduling server 50 is equipped with a data storage area 55 that can also be internal, external or removable. The scheduling server 50 may also include a scheduling module (not shown) that is configured to maintain a calendar of events or other schedule related information for the various handsets such as handsets 20, 30 and 40.

The location server 60 is also equipped with a data storage area 65 that can also be internal, external or removable. The location server 60 may also have a location module (not shown) that is configured to track the location of various handsets such as handsets 20, 30 and 40. The location module may also perform the function of identifying the location of a handset using well known triangulation techniques in combination with information from base stations such as base stations 72 and 74. The location module may also use global positioning system (“GPS”) information from a handset to track the location of a handset.

The location server 60 may also receive and route location requests to and from handsets and other devices (not shown) that are capable of communicating with the server 60 via the network 70 or any other network that the server 60 may be connected to. For example, the server 60 may also be connected to the Internet, through network 70 or otherwise, such that a device capable of communicating with the server 60 via the Internet can request the location of handsets from the server 60.

FIG. 2 is a block diagram illustrating an example handset 20 that is part of a system for scheduling meetings according to an embodiment of the present invention. In the illustrated embodiment, the handset 20 comprises a scheduling module 100, a roll call module 110 and a location module 120.

The scheduling module 100 is configured originate meeting requests for a meeting organizer and respond to meeting requests for a potential attendee. For example the scheduling module 100 can receive meeting or event parameters from the user of the handset 20 (e.g., the meeting organizer) and tentatively schedule an event on the organizer's calendar. The scheduling module 100 is additionally configured to receive the names of potential attendees and look up those individuals in the contacts list on the handset 20. After looking up the contact entry for a potential attendee, the scheduling module 100 can send a communication to the potential attendee to determine if the potential attendee is available for the meeting. If the potential attendee is available, the scheduling module can change the tentatively scheduled event on the organizer's calendar to a scheduled event and add the respondent's name to a list of confirmed attendees. According to one embodiment, the scheduling server 50, shown in FIG. 1 maintains updated schedules for participants of the service such that the scheduler can query the scheduling server 50 to determine availability of a potential meeting participant.

In one embodiment, the scheduling module 100 may keep track of the number of confirmed attendees and only change a tentatively scheduled event to a scheduled event when a certain number of confirmed attendees meet a predetermined or dynamically determined threshold. For example, when scheduling a poker game the threshold may be predetermined at four confirmed attendees. Alternatively, when scheduling a meeting for a decision making body, the scheduling module 100 may dynamically determine the number of confirmed attendees required for a quorum given the number of invitees.

On a potential attendee's (invitee's) handset, the scheduling module 100 is configured to receive meeting or event invitations and consult the invitee's calendar and preferences, etc. to determine availability and either automatically response, for example according to preferences, or query the invitee for a response to the invitation. The scheduling module 100 is also configured to send a response to the meeting organizer.

The roll call module 110 is configured to take a roll call at the scheduled start time of the meeting or event. The roll call may also be taken at the scheduled end time or at any other time that may be helpful in scheduling and carrying out meetings and events. The roll call module 110 is configured to take a roll call wirelessly. In one embodiment, the roll call is taken by consulting the list of confirmed attendees and then sending direct wireless communication to the handset for the confirmed attendee to verify the presence of the confirmed attendee. For example, a Bluetooth query or an infrared (IR) query could be sent and attendance confirmed by an appropriate response from the roll call module 100 on the handset of the confirmed attendee.

In an alternative embodiment, or in combination with the direct confirmation, the roll call module 100 may take the roll call by sending an indirect wireless communication to the handset for a confirmed attendee. For example, the presence of the confirmed attendee's handset can be confirmed by a location request sent to the network, which may determine the location by GPS or triangulation or other location techniques.

Additionally, or alternatively, the roll call module 100 may take the roll call by sending a data communication to the handset of a confirmed attendee. For example, an SMS or MMS message or other type of message can be sent to a confirmed attendee's handset with instructions for the handset to automatically respond to the roll call message to indicate the location of the confirmed attendee's handset. The confirmed attendee's handset may need to first identify its location and this can be done using GPS or triangulation techniques or by querying the network for its location utilizing, for example, the location server 60 as shown in FIG. 1. On a confirmed attendee's handset, the roll call module 110 may be tasked with responding to the direct or indirect wireless roll call inquiries. In one embodiment, the roll call module 110 may be configured to provide a predetermined response, regardless of the actual attendance status of the confirmed attendee.

The location module 120 is configured to identify the location of a handset. On the meeting organizer's handset, the location module 120 may work in concert with the roll call module 100 to identify the location of confirmed attendees who are not at the designated meeting location at the appointed time. For example, the location module 120 may receive a list of one or more confirmed attendees who are not present for the meeting and attempt to identify their location. In one embodiment, the roll call module 110 may only determine that the confirmed attendees are not present. In such an embodiment, the location module may attempt to determine the actual location of the non-present confirmed attendees and report these locations to the organizer so the organizer can decide if it would be beneficial to call the confirmed attendee, for example to assist with location specific directions or otherwise facilitate attendance or confirm non-attendance. On a confirmed attendee's handset, the location module 120 may receive location requests and respond accordingly to provide its location or a predetermined location.

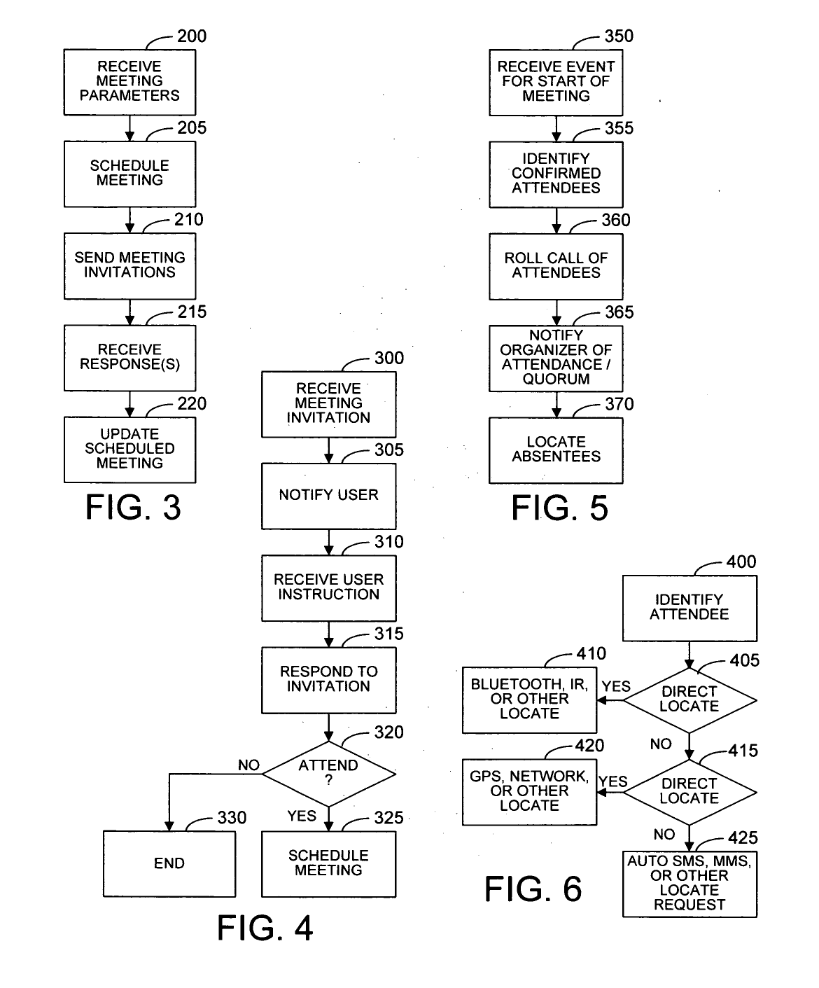

FIG. 3 is a flow diagram illustrating an example process for scheduling a meeting by an organizer according to an embodiment of the present invention. This process may be carried out by a scheduling module on a handset such as the scheduling module described with respect to FIG. 2. Certain details and features may have been left out of the flow chart FIG. 3 that are apparent to a person of ordinary skill in the art. For example, a step may consist of one or more sub-steps or may involve specialized equipment or materials, as known in the art. While steps 200 through 220 are sufficient to describe one embodiment of the present invention, other embodiments of the invention may utilize steps different from those shown in the flow chart of FIG. 3.

Initially, the handset receives certain meeting parameters from the organizer, as shown in step 200. The meeting parameters may include the date, time, and location of the meeting. The parameters may also include other information such as a minimum number of confirmed attendees, the subject matter for the meeting/event, a password, cover charge, list of invitees, and other useful information.

Next, in step 205 a meeting is tentatively scheduled on the organizer's handset, for example, in the calendar section or to do list. The meeting can be tentatively scheduled or it can be regularly scheduled, depending on the preference of the organizer. If tentatively scheduled, the meeting can later be changed so that the tentative designation is removed. Similarly, if the meeting is regularly scheduled it can later be changed to indicate that the meeting is tentative, for example if no invitees confirm their attendance within a certain period of time from the invitation or before the meeting time.

In step 210, the handset sends meeting invitations to the list of invitees provided by the organizer. Advantageously, the handset can consult a contacts list on the handset to identify the address information for the list of invitees. In this fashion, the meeting invitations may be sent to the potential attendees via simple message system (“SMS”), multimedia message system (“MMS), infrared (“IR”), Bluetooth, email, or other wireless communication means.

Once the invitations have been sent (or a portion of the invitations have been sent) the handset of the organizer may begin to receive responses from the invitees, as shown in step 215. These responses may be received by any of the above identified communication means, or delivered to the organizer and manually input into the organizer's handset through the user interface (e.g., keys, voice, multi-directional pad, etc.). Upon receiving a response, the handset can then update the scheduled or tentatively scheduled meeting accordingly, as shown in step 220. For example, if a meeting was tentatively scheduled, then the handset may “ink” the meeting by removing the tentative designation for the scheduled meeting. As mentioned above, the scheduling server 50 illustrated in FIG. 1 may also maintain an updated meeting schedule with confirmed and invited attendees, according to one embodiment of the invention.

FIG. 4 is a flow diagram illustrating an example process for scheduling a meeting by an invitee according to an embodiment of the invention. This process may be carried out by a scheduling module on an invitee's handset such as the scheduling module previously described with respect to FIG. 1. Certain details and features may have been left out of the flow chart FIG. 4 that are apparent to a person of ordinary skill in the art. For example, a step may consist of one or more sub-steps or may involve specialized equipment or materials, as known in the art. While steps 300 through 330 are sufficient to describe one embodiment of the present invention, other embodiments of the invention may utilize steps different from those shown in the flow chart of FIG. 4.

Initially, in step 300 the invitee's handset receives the meeting invitation. The invitation may be received by a variety of communication means as previously described. Next, in step 305 the handset notifies the potential attendee of the invitation. The notification may be conveyed through the user interface, via an audible signal, a blinking light, vibrating buzzer, or creating a message for the invitee's inbox or some other means. In step 310 the handset receives an instruction from the invitee regarding the invitation. For example, the instruction may be to confirm the invitee's attendance, decline the invitation, or otherwise provide an indication of the invitee's potential attendance such as maybe, strong maybe, likely not, etc. Accordingly, the handset sends a response to the invitation with a yes, no, or, in one embodiment, some indication of the likelihood of attendance.

In step 320, the handset determines if the invitee is going to attend the meeting. If the invitee is not going to attend, the process ends in step 330. If the invitee is going to attend, or if there is any indication that the invitee may attend, then the handset schedules the meeting in step 325. In one embodiment, the scheduling of the meeting may be tentative or verified, depending on the instruction from the invitee that was received in step 310. Accordingly, the scheduling of the meeting in step 325 may be a regularly scheduled meeting or a tentatively scheduled meeting. This information may be forwarded to the scheduling server 50 as illustrated in FIG. 1 according to one embodiment.

FIG. 5 is a flow diagram illustrating an example process for initiating a scheduled meeting according to an embodiment of the present invention. This process may be carried out by a roll call module such as that previously described with respect to FIG. 1. Certain details and features may have been left out of the flow chart FIG. 5 that are apparent to a person of ordinary skill in the art. For example, a step may consist of one or more sub-steps or may involve specialized equipment or materials, as known in the art. While steps 350 through 370 are sufficient to describe one embodiment of the present invention, other embodiments of the invention may utilize steps different from those shown in the flow chart of FIG. 5.

Initially, in step 350 the handset receives a trigger that a meeting is starting. For example, an alarm for the meeting might be the trigger or a five (5) minute warning might be the trigger that indicates that the initiation process should commence. Other indications of the start of an event or meeting may also be employed. In one embodiment the network may send a signal or message that indicates that a meeting or event is about to begin. For example, if the network maintains a group calendar then the network may send the signal that indicates the start of an event or meeting.

Next, in step 355 the handset identifies the list of confirmed attendees for the meeting. This may be accomplished by consulting the scheduled meeting on the calendar of the handset or by reading a file that is associated with the calendar event or scheduled meeting. Additionally, the list of attendees may be received from the network. Once the list of attendees has been obtained, the handset takes a roll call of the confirmed attendees, as shown in step 360.

In one embodiment, the roll call may be accomplished by sending an IR message directly to each handset for each confirmed attendee. Alternatively, a Bluetooth message may be sent directly to each handset. The responses from the various handsets that receive the direct wireless message are then collected as part of the roll call and compared to the list of confirmed attendees to determine who is not present. In another embodiment, the roll call may be accomplished with indirect messages, for example, a location request through a wireless communication network. An indirect message can be a location request to a location server 60, as shown in FIG. 1, or a GPS or triangulation location request for the target device (e.g., the handset of the confirmed attendee). Additional techniques for locating a handset may also be employed by the roll call process, as will be understood by those having skill in the art.

Once the roll call has been taken, in step 365 the handset notifies the organizer of the attendance for the meeting or event. In one embodiment, the handset may notify the organizer if a quorum is present or if certain specifically identified confirmed attendees are present, such as a sergeant at arms, vice president, dealer, or other critical person for whatever the meeting or event might be.

Finally, in step 370 the handset locates the absentees. In one embodiment, locating absentees may be carried out through a network based location query to identify the location of the handsets for the confirmed attendees that are absent. For example, the network may continuously track the location of a handset and respond to the organizer's handset with the location information of absentee handsets. In one embodiment, if an absentee handset is within a certain range of the organizer's handset, for example, 10 meters, a subsequent roll call procedure may be employed to determine whether the confirmed attendee is in fact present. If the location of the absentees is available, that information may be stored by the organizer's handset for later use.

FIG. 6 is a block diagram illustrating an example process for taking roll call at a scheduled meeting according to an embodiment of the present invention. The roll call process may be implemented by an organizer's handset such as that previously described with respect to FIGS. 1 and 2. Alternatively, a deputy handset or roll call agent may be engaged to carry out the roll call process. Certain details and features may have been left out of the flow chart FIG. 6 that are apparent to a person of ordinary skill in the art. For example, a step may consist of one or more sub-steps or may involve specialized equipment or materials, as known in the art. While steps 400 through 425 are sufficient to describe one embodiment of the present invention, other embodiments of the invention may utilize steps different from those shown in the flow chart of FIG. 6.

Initially, in step 400 the list of confirmed attendees is identified. Next, in step 405 the handset determines if the confirmed attendee can be located using a direct locate method, for example Bluetooth or IR. If so, then in step 410 a direct location message is sent to the confirmed attendee's handset to determine if a response is received indicating the confirmed attendee's presence. In one embodiment, if no response is received, the confirmed attendee is considered absent. If a response is received, the confirmed attendee is considered present.

If the confirmed attendee is not able to receive a direct locate message, as determined in step 405, the handset determines in step 415 if the confirmed attendee can be located using a remote locate method, for example GPS, triangulation, or other network based location technique. If so, then in step 420 a remote location message is sent to the confirmed attendee's handset to determine if a response is received indicating the confirmed attendee's presence. In one embodiment, if no response is received, the confirmed attendee is considered absent. If a response is received, the confirmed attendee is considered present.

If a remote location technique is not available for the confirmed attendee, then in step 425 the handset sends a network based roll call message to the confirmed attendee. Such a message may be an SMS message, MMS message, an email, or some other type of message that the confirmed attendee handset will respond to. The response from the confirmed attendee may include the GPS coordinates or other location information to confirm the presence of the confirmed attendee at the appointed location of the meeting or event. This process may loop back through the list of all confirmed attendees so that the presence or absence of all confirmed attendees is determined. Alternatively, all confirmed attendees may be simultaneously queried for their presence rather than serially queried. Confirmed attendees may also be simultaneously queried by direct (at least those capable) and then simultaneously queried by remote (at least those capable) and then simultaneously queried by network message (at least those capable) in a serial fashion. In one embodiment, it may be advantageous to send multiple types of locate messages to each confirmed attendee to combat location spoofing by the confirmed attendee.

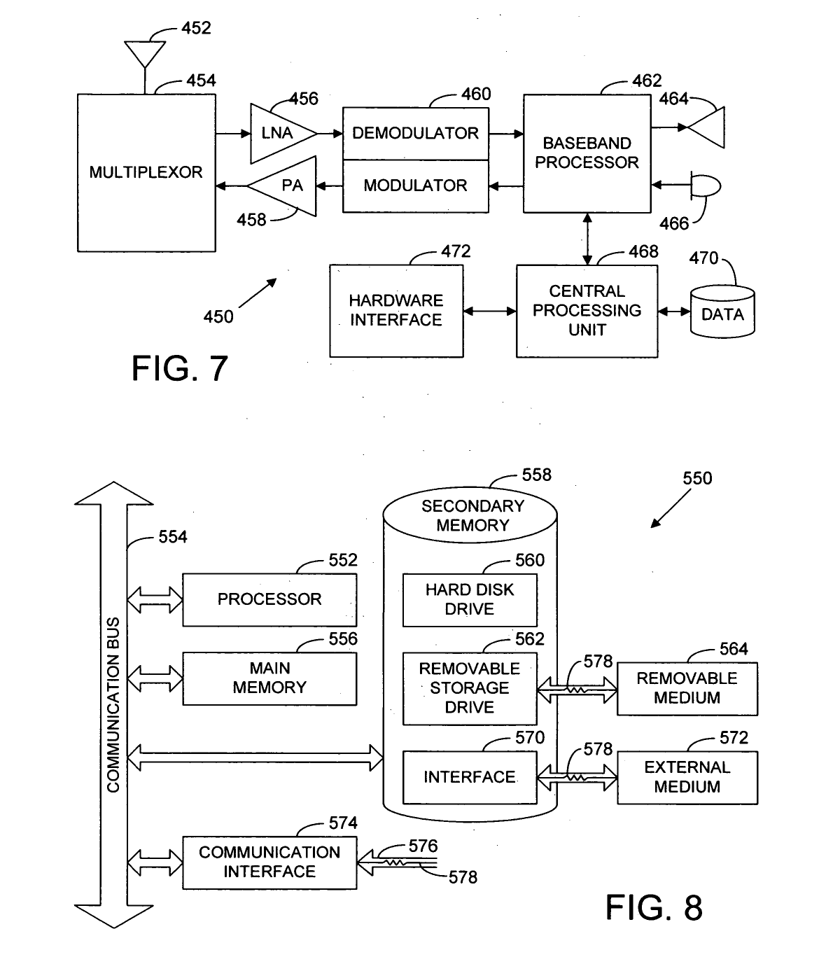

FIG. 7 is a block diagram illustrating an exemplary wireless communication device 450 that may be used in connection with the various embodiments described herein. For example, the wireless communication device 450 may be used in conjunction with a handset as described above with respect to FIG. 1. However, other wireless communication devices and/or architectures may also be used, as will be clear to those skilled in the art.

In the illustrated embodiment, wireless communication device 450 comprises an antenna 452, a multiplexor 454, a low noise amplifier (“LNA”) 456, a power amplifier (“PA”) 458, a modulation circuit 460, a baseband processor 462, a speaker 464, a microphone 466, a central processing unit (“CPU”) 468, a data storage area 470, and a hardware interface 472. In the wireless communication device 450, radio frequency (“RF”) signals are transmitted and received by antenna 452. Multiplexor 454 acts as a switch, coupling antenna 452 between transmit and receive signal paths. In the receive path, received RF signals are coupled from a multiplexor 454 to LNA 456. LNA 456 amplifies the received RF signal and couples the amplified signal to a demodulation portion of the modulation circuit 460.

Typically modulation circuit 460 will combine a demodulator and modulator in one integrated circuit (“IC”). The demodulator and modulator can also be separate components. The demodulator strips away the RF carrier signal leaving a base-band receive audio signal, which is sent from the demodulator output to the base-band processor 462. If the base-band receive audio signal contains audio information, then base-band processor 462 decodes the signal and converts it to an analog signal. Then the signal is amplified and sent to the speaker 464. The base-band processor 462 also receives analog audio signals from the microphone 466. These analog audio signals are converted to digital signals and encoded by the base-band processor 462. The base-band processor 462 also codes the digital signals for transmission and generates a base-band transmit audio signal that is routed to the modulator portion of modulation circuit 460. The modulator mixes the base-band transmit audio signal with an RF carrier signal generating an RF transmit signal that is routed to the power amplifier 458. The power amplifier 458 amplifies the RF transmit signal and routes it to the multiplexor 454 where the signal is switched to the antenna port for transmission by antenna 452.

The baseband processor 462 is also communicatively coupled with the central processing unit 468. The central processing unit 468 has access to a data storage area 470. The central processing unit 468 is preferably configured to execute instructions (i.e., computer programs or software) that can be stored in the data storage area 470. Computer programs can also be received from the baseband processor 462 and stored in the data storage area 470 or executed upon receipt. Such computer programs, when executed, enable the wireless communication device 450 to perform the various functions of the present invention as previously described.

For example, data storage area 470 may include a schedule meeting module, roll call module, and/or location module (all not shown) that integrate with the operating system or module that controls the operation of the device 450. Accordingly, these modules may extend the functionality of the device 450 to allow for the scheduling of meetings and the verification of attendees at the scheduled meeting time and place.

In this description, the term “computer readable medium” is used to refer to any media used to provide executable instructions (e.g., software and computer programs) to the wireless communication device 450 for execution by the central processing unit 468. Examples of these media include the data storage area 470, microphone 466 (via the baseband processor 462), antenna 452 (also via the baseband processor 462), and hardware interface 472. These computer readable mediums are means for providing executable code, programming instructions, and software to the wireless communication device 450. The executable code, programming instructions, and software, when executed by the central processing unit 468, preferably cause the central processing unit 468 to perform the inventive features and functions previously described herein.

FIG. 8 is a block diagram illustrating an exemplary computer system 550 that may be used in connection with the various embodiments described herein. For example, the computer system 550 may be used in conjunction with a scheduling server or location server as previously described with respect to FIG. 1. However, other computer systems and/or architectures may be used, as will be clear to those skilled in the art.

In the illustrated embodiment, the computer system 550 preferably includes one or more processors, such as processor 552. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 552.

The processor 552 is preferably connected to a communication bus 554. The communication bus 554 may include a data channel for facilitating information transfer between storage and other peripheral components of the computer system 550. Computer system 550 preferably includes a main memory 556 and may also include a secondary memory 558. The main memory 556 provides storage of instructions and data for programs executing on the processor 552. The main memory 556 is typically semiconductor-based memory such as dynamic random access memory (“DRAM”) and/or static random access memory (“SRAM”). Other semiconductor-based memory types include, for example, synchronous dynamic random access memory (“SDRAM”), Rambus dynamic random access memory (“RDRAM”), ferroelectric random access memory (“FRAM”), and the like, including read only memory (“ROM”).

The secondary memory 558 may optionally include a hard disk drive 560 and/or a removable storage drive 562, for example a floppy disk drive, a magnetic tape drive, a compact disc (“CD”) drive, a digital versatile disc (“DVD”) drive, etc. The removable storage drive 562 reads from and/or writes to a removable storage medium 564 in a well-known manner. Removable storage medium 564 may be, for example, a floppy disk, magnetic tape, CD, DVD, etc. In alternative embodiments, secondary memory 558 may include other similar means for allowing computer programs or other data or instructions to be loaded into the computer system 550. Such means may include, for example, an external storage medium 572 and an interface 570. Examples of external storage medium 572 may include an external hard disk drive or an external optical drive, or and external magneto-optical drive.

Computer system 550 may also include a communication interface 574. The communication interface 574 allows software and data to be transferred between computer system 550 and external devices (e.g. printers), networks, or information sources. For example, computer software or executable code may be transferred to computer system 550 from a network server via communication interface 574. Examples of communication interface 574 include a modem, a network interface card (“NIC”), a communications port, a PCMCIA slot and card, an infrared interface, and an IEEE 1394 fire-wire, just to name a few.

Communication interface 574 preferably implements industry promulgated protocol standards, such as Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/Internet protocol (“TCP/IP”), serial line Internet protocol/point to point protocol (“SLIP/PPP”), and so on, but may also implement customized or non-standard interface protocols as well.

Software and data transferred via communication interface 574 are generally in the form of electrical communication signals 578 provided to communication interface 574 via a communication channel 576. Communication channel 576 carries signals 578 and can be implemented using a variety of wired or wireless communication means including wire or cable, fiber optics, conventional phone line, cellular phone link, wireless data communication link, radio frequency (RF) link, or infrared link, just to name a few.

Computer executable code (i.e., computer programs or software) is stored in the main memory 556 and/or the secondary memory 558. Computer programs can also be received via communication interface 574 and stored in the main memory 556 and/or the secondary memory 558. Such computer programs, when executed, enable the computer system 550 to perform the various functions of the present invention as previously described.

In this description, the term “computer readable medium” is used to refer to any media used to provide computer executable code (e.g., software and computer programs) to the computer system 550. Examples of these media include main memory 556, secondary memory 558 (including hard disk drive 560, removable storage medium 564, and external storage medium 572), and any peripheral device communicatively coupled with communication interface 574 (including a network information server or other network device). These computer readable mediums are means for providing executable code, programming instructions, and software to the computer system 550.

In an embodiment that is implemented using software, the software may be stored on a computer readable medium and loaded into computer system 550 by way of removable storage drive 562, interface 570, or communication interface 574. In such an embodiment, the software is loaded into the computer system 550 in the form of electrical communication signals 578. The software, when executed by the processor 552, preferably causes the processor 552 to perform the inventive features and functions previously described herein.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly limited by nothing other than the appended claims.

What is claimed is:

1. A method for scheduling a meeting between individual users of wireless communication devices, comprising:
receiving meeting parameters from a meeting organizer utilizing a wireless communication device, the meeting parameters comprising a meeting time, a meeting location, and at least one invitee, wherein the at least one invitee is an individual with a contact record in a contact list stored in a data storage area on the wireless communication device, the contact record having an electronic address for a wireless communication associated with the at least one individual;
scheduling a meeting on the wireless communication device;
sending a meeting invitation via a wireless communication network to the at least one invitee, the meeting invitation comprising the meeting parameters;
receiving a response from the at least one invitee via a wireless communication network;
updating the scheduled meeting to identify the at least one invitee sending an affirmative response to the meeting invitation as a confirmed attendee;
compiling a list of confirmed attendees at the meeting time; and
verifying, at the scheduled meeting time, the presence of each confirmed attendee at the meeting location.

2. The method of claim 1, wherein the step of scheduling a meeting comprises storing an item on a to do list or in a calendar on the wireless communication device.

3. The method of claim 1, wherein the step of scheduling a meeting comprises initially identifying the at least one invitee as a non-attendee.

4. The method of claim 1, wherein sending the meeting invitation comprises at least one of (1) sending an SMS or MMS voice channel network communication; (2) sending an email or other 802.11 data network communication; and (3) sending a direct wireless communication.

5. The method of claim 1, wherein the direct wireless communication is an IR communication.

6. The method of claim 1, wherein the direct wireless communication is a Bluetooth communication.

7. The method of claim 1, wherein the step of verifying the presence of the each confirmed attendee comprises sending a location request to the each confirmed attendee, receiving a location, and comparing the received location to the meeting location; and if the received location does not match the meeting location, then sending an reminder message to the confirmed attendee.

8. The method of claim 1, wherein the received location is determined from at least one of a GPS location, a triangulation, or a network based location tracking.

9. A wireless communication device, comprising:
a contact list comprising a plurality of contact records, each contact record having an address field configured to store an electronic address for a wireless communication device associated with the respective contact record, wherein each contact record represents a potential invitee;
a scheduling module configured to send a meeting request comprising meeting parameters to one or more invitees, the scheduling module further configured to receive a response from a first invitee, determine that the response is affirmative, and identify said first invitee as a confirmed attendee; and
a roll call module configured to verify, at the scheduled time for the meeting, the presence of confirmed attendees.

10. The wireless communication device of claim 9, wherein the roll call module is configured to verify by at least one of (1) IR; (2) Bluetooth; (3) SMS/MMS; (4) GPS; and (5) email.

11. The wireless communication device of claim 9, wherein the roll call module is configured to send a meeting reminder to confirmed attendees not present.

12. The wireless communication device of claim 9, further comprising a location module configured to identify the location of a confirmed attendee who is not present at the meeting location at the scheduled meeting time.
